(19) United States
(12) Patent Application Publication
(10) Pub. No.: US 2003/0025684 A1
(43) Pub. Date: Feb. 6, 2003

(54) Driving method for a power-saving thin film transistor array

(75) Inventors: Tsung-Pei Chiang, Hsinchu Hsien (TW); Chun-Chin Tseng, Changhua Hsien (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU Optronics Corp.

(21) Appl. No.: 10/067,680

(22) Filed: Feb. 4, 2002

(30) Foreign Application Priority Data
Aug. 1, 2001 (TW) 90118744

(51) Int. Cl. G09G 5/00

(52) U.S. Cl. 345/204

(57) ABSTRACT

The invention is a driving method for a Thin Film Transistor (TFT) array, capable of saving power, using an Application Specific Integrated Circuit (ASIC) chip to control the different driving modes in graphic and non-graphic zones, thereby saving driving power. The driving method includes the following steps: implementing an Application Specific Integrated Circuit (ASIC) chip; determining a predetermined mode; dividing a Thin Film Transistor (TFT) frame into a plurality of zones according to the predetermined mode; and determining the driving mode required by each zone through a control signal activated by the ASIC chip according to the plurality of zones.

### BACKGROUND OF THE INVENTION

1. Field of the Invention

The invention relates to a display panel driving method. Particularly, the invention relates to a driving method for a Thin Film Transistor (TFT) array which saves power by different driving modes applied to a display panel at graphic and non-graphic regions.

2. Description of the Related Art

Typically, signal inversion is used to drive a TFT array. Currently, frame inversion and the line inversion are widely used. When frame inversion is used, as shown in FIG. 1, the entire frame shows the same voltage level. Thus a TFT array is driven by continuously interlacing a positive voltage frame and a negative voltage frame. In such a mode, it can save power because of the lower driving power requirements. However, it can easily cause flicker, reducing frame quality. When line inversion is used, as shown in FIG. 2, a scan line has the same voltage level on a frame but two adjacent scan lines have the opposite voltage level, i.e., the odd and even scan lines are in inverted phase to one another, thereby reducing flicker. However, the inverted phase between the adjacent scan lines uses more power than the frame inversion to change phase to the opposite. Obviously, using only an inversion as mentioned above cannot provide both lower power consumption and better frame quality at the same time.

### SUMMARY OF THE INVENTION

Accordingly, an object of the invention is to provide a driving method for a Thin Film Transistor (TFT) array that saves power by the application of different driving modes to a display panel at graphic and non-graphic regions.

The invention uses an Application Specific Integrated Circuit (ASIC) chip to control the different driving modes in graphic and non-graphic regions, thereby saving driving power. The driving method includes the following steps: implementing an Application Specific Integrated Circuit (ASIC) chip; determining a predetermined mode; dividing a Thin Film Transistor (TFT) frame into a plurality of zones according to the predetermined mode; and determining the driving mode required by each zone through a control signal activated by the ASIC chip according to the plurality of zones.

### BRIEF DESCRIPTION OF THE DRAWINGS

The aforementioned objects, features and advantages of this invention will become apparent by referring to the following detailed description of a preferred embodiment with reference to the accompanying drawings, wherein:

FIG. 1 is a schematic diagram of a typical driving method of frame inversion;

FIG. 2 is a schematic diagram of a typical driving method of line inversion;

FIG. 3 shows a block diagram of the inventive structure;

FIG. 4 shows an embodiment of the operation timing according to the invention;

FIG. 5 shows a schematic diagram of an embodiment of a TFT driving mode according to the invention; and

FIG. 6 shows a flowchart diagram of the inventive method.

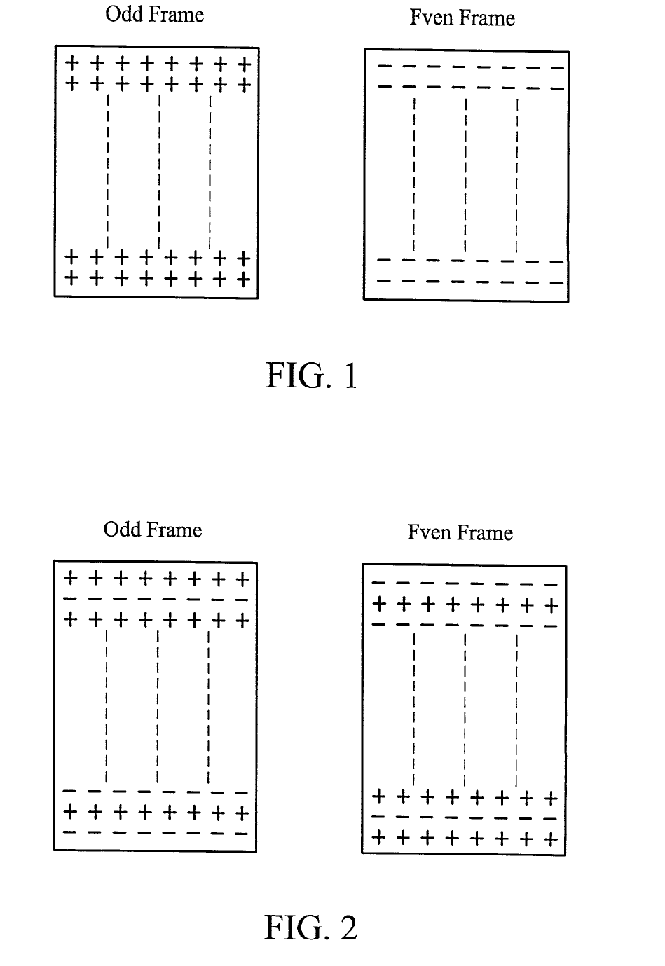

### DETAILED DESCRIPTION OF THE INVENTION

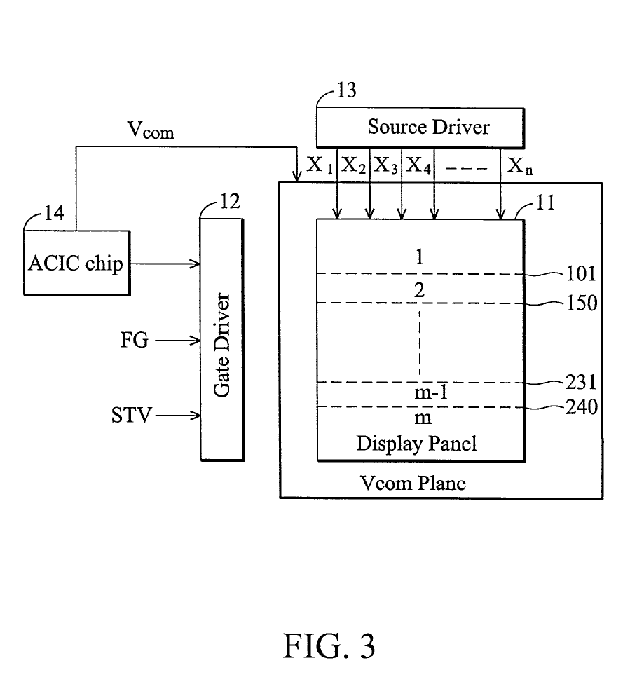

FIG. 3 shows a block diagram of the inventive structure. In FIG. 3, besides the typical display panel structure, which includes a display panel 11, a gate driver 12, and a source driver 13, an ASIC chip 14 is included. As shown in FIG. 3, the system externally connects the ASIC chip 14 to the gate driver 12 to activate a control signal Vcom from the chip 14 to the gate driver 12, plus a start signal STV and a clock signal FG input to the gate driver 12, so as to divide a display frame, e.g. the TFT array display panel 11 used in a cellular phone, into a plurality of zones. The plurality of zones are grouped into graphic and non-graphic regions, according to the predetermined display mode, for example, standby mode, graphic mode, and video mode. Therefore, the TFT array display panel is divided into, for example, 1-m zones. In the 1-m zones, a line inversion is used to drive the zones belonging to the graphic region (i.e., the 2^{nd} zone and the m-1th zone). Otherwise, a frame inversion is used to drive the remaining zones, which belong to the non-graphic region (i.e., all zones except for the 2^{nd} and m-1th zones). Thus, the display panel will have the best performance and consume the fewest resources. The operation timing of the signals Vcom, STV, FG, and the data output signals X₁ to Xₙ is described in detail as follows.

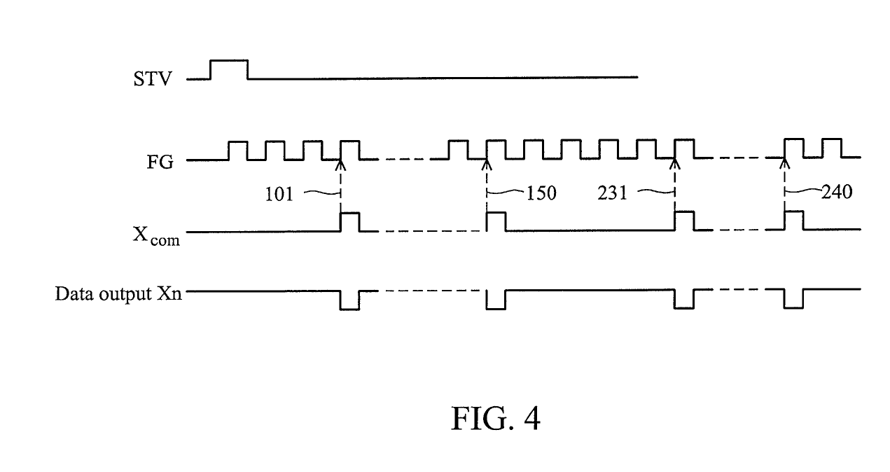

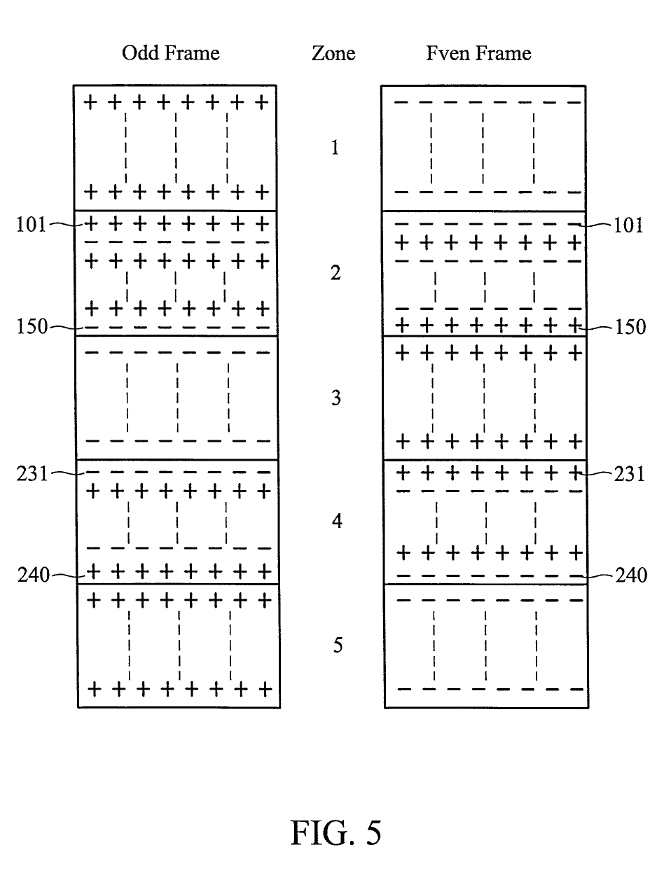

FIG. 4 shows an embodiment of the operation timing according to the invention. As shown in FIG. 4, in the example of the two graphic zones from the scan lines 101-150 and 231-240, when the signal STV goes to high level, the signal FG begins to count the clock number. When the clock number reaches 101, the data output signal Xₙ (101≦n≦150) and the signal Vcom are output as shown in FIG. 4. At this point, as shown in FIG. 5, the scan lines 101-150 are switched from the frame inversion to the line inversion according to the signal Vcom and the data output signal Xₙ (101≦n≦150). Likewise, when the signal FG counted in FIG. 4 is between 231 and 240, the clock controls the data output signal Xₙ (231≦n≦240) and the signal Vcom as shown in FIG. 5. The scan lines 231-240 are also switched from the frame inversion to the line inversion according to the signal Vcom and the data output signal Xₙ (231≦n≦240). The remaining scan lines (located on the zones 1, 3, 5) are still driven by the frame inversion. The display panel can be any TFT array display panel. In this example, a frame is divided into five zones due to the two graphic zones. This is, however, only for purposes of clarity and illustration, and is not intended to be limiting. The number of zones divided on a frame is based on practical implementation.

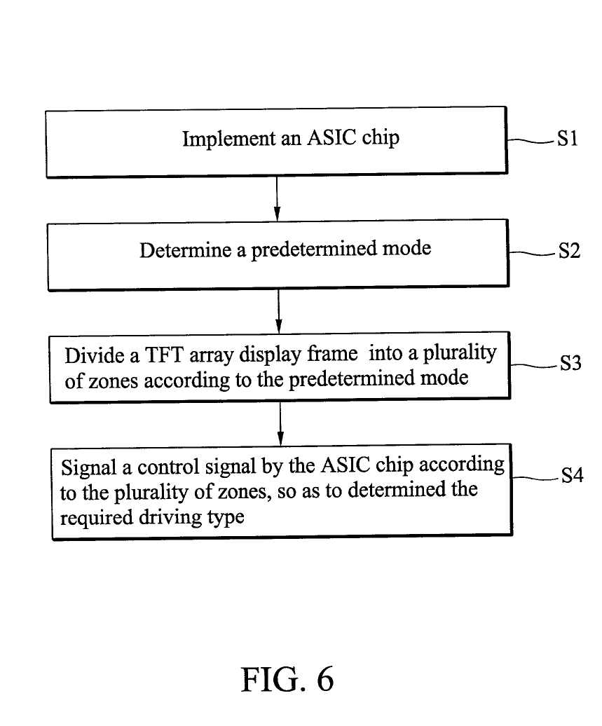

FIG. 6 shows a flowchart of the inventive method. In FIG. 6, the method includes: implementing an Application Specific Integrated Circuit (ASIC) chip (S1); determining a predetermined mode (S2); dividing a Thin Film Transistor (TFT) frame into a plurality of zones according to the predetermined mode (S3); determining the driving mode required by each zone through a control signal activated by the ASIC chip according to the plurality of zones (S4).

As shown in FIG. 6, the implementation of an ASIC chip connects the output control signal Vcom of the ASIC chip to the Vcom signal control plane so as to complete the ASIC chip implementation (S1). The ASIC chip is designed to drive the different zones on a display frame by the different inversions. A central processing unit (CPU; not shown) or operating system (OS; not shown) determines a predetermined mode of a display frame (S2), wherein the predetermined mode includes standby, graphic, and video modes. The display frame is divided into a plurality of zones according to the predetermined mode (S3). The CPU or OS signals the data associated with the plurality of zones to the ASIC chip so that the ASIC chip activates a control signal to perform the required driving type on each zone (S4). The number of zones can change with the modes, determined by the manufacturer. For example, a manufacturer may put their logo in the upper portion of a frame during standby mode and another manufacturer may put their logo on the first and last lines of a frame.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A driving method for a Thin Film Transistor (TFT) array, capable of saving power, comprising the steps:
implementing an Application Specific Integrated Circuit chip;
determining a predetermined mode;
dividing a Thin Film Transistor array frame into a plurality of zones according to the predetermined mode, wherein the plurality of zones are grouped into graphic and non-graphic regions; and
signaling a control signal by the Application Specific Integrated Circuit to determine the driving type required for each zone according to the plurality of zones grouped.

2. The method of claim 1, wherein the predetermined mode is a standby mode.

3. The method of claim 1, wherein the predetermined mode is a graphic mode.

4. The method of claim 1, wherein the predetermined mode is a video mode.

5. The method of claim 1, wherein the predetermined mode is dictated by the manufacturer.

6. The method of claim 1, wherein the graphic and non-graphic regions located on a frame are determined by the manufacturer.

7. The method of claim 1, wherein the driving type in the graphic region uses a line inversion.

8. The method of claim 1, wherein the driving type in the non-graphic region uses a frame inversion.

9. The method of claim 1, wherein the step of determining a predetermined mode is performed by a central processing unit (CPU).

10. The method of claim 1, wherein the step of determining a predetermined mode is performed by an operating system.

11. The method of claim 1, further comprising a step of signaling the data associated with the plurality of zones to the ASIC chip after the dividing step
